(19) United States
(12) Patent Application Publication
(10) Pub. No.: US 2014/0064646 A1
(43) Pub. Date: Mar. 6, 2014

(54) LOW-FRICTION, ABRASION RESISTANT REPLACEABLE BEARING SURFACE

(71) Applicant: Superior Drilling Products LLC, Vernal, UT (US)

(72) Inventors: Gilbert Troy Meier, Vernal, UT (US); James D. Isenhour, Windsor, CO (US)

(73) Assignee: Superior Drilling Products LLC, Vernal, UT (US)

(21) Appl. No.: 14/018,066

(22) Filed: Sep. 4, 2013

Related U.S. Application Data
(60) Provisional application No. 61/696,738, filed on Sep. 4, 2012.

(51) Int. Cl. F16C 35/00

(52) U.S. Cl. CPC F16C 35/00
USPC 384/428; 29/898.07

(57) ABSTRACT

A replaceable bearing surface is disclosed. The replaceable bearing surface comprises an outer housing and a low-friction, abrasion resistant button secured within the outer housing. The outer housing is adapted to be inserted into and removed from a device without damaging the device.

### REFERENCE TO RELATED APPLICATIONS

This application claims priority to provisional application U.S. Provisional Application Ser. No. 61/696738, filed Sep. 4, 2012, and entitled “LOW-FRICTION, ABRASION RESISTANT REPLACEABLE BEARING SURFACE,” which is specifically and entirely incorporated by reference.

### BACKGROUND

1. Field of the Invention

The invention is directed to friction reducing devices. In particular, the invention is directed to low-friction, abrasion resistant replaceable friction reducing bearing surfaces.

2. Background of the Invention

Many industries, including but not limited to oil well drilling, machining, mining, quarrying, and transportation, use mechanisms that need to work under high pressure and high temperature conditions. Furthermore, parts of the mechanisms often rub against each other or external surfaces and, therefore, a low friction, abrasion resistant surface in these parts is desired.

One solution, for example, is a bearing surface comprised of Polycrystalline Diamond Compact (PDC), a synthetic diamond that performs under harsh conditions. PDC is diamond grit that has been fused together under high-pressure, high-temperature conditions in the presence of a catalytic metal. The extreme hardness, wear resistance, and thermal conductivity of diamond make it an ideal material for bearings. Individual diamond crystals cleave quite easily when struck parallel to certain planes (the process used to facet diamond gemstones takes advantage of these relatively weak planes). Diamond sintering overcomes the problem of weak planes in diamond gemstones by bonding a mass of small diamond particles onto a larger, coherent structure. Sintered diamond provides greater toughness and durability than single crystals because the individual crystals in a sintered body are randomly oriented. This prevents cracks from propagating along the weak planes where traditional diamond crystals cleave most easily. Sintered diamonds also provide more uniform wear than a single crystal, while maintaining similar thermal conductivity and hardness properties. All of these factors combine to make sintered diamond the ideal material for many bearing applications.

However, overtime, PDC bearings do wear out and can become damaged from intensive use. The PDC bearings are usually embedded into the device by welding and, therefore, in order to replace the PDC bearings, the parts must be removed from operation and transported to a specialized facility that is able to remove the worn out PDC bearings and replace them with new bearings. The process is both costly and time consuming. Furthermore, the repeated heating and cooling needed to replace the bearings causes excessive stress on the devices. Additionally, the welded or brazed bearing pads currently used during refurbishment cannot maintain precision tolerances, especially after multiple replacements. Therefore, it is desirable to have a replaceable low-friction, abrasion resistant bearing surface capable of being replace quickly on-site.

### SUMMARY OF THE INVENTION

The present invention overcomes the problems and disadvantages associated with current strategies and designs and provides new tools and methods of providing replaceable low-friction, abrasion resistant bearing surfaces.

One embodiment of the invention is directed to a replaceable bearing surface. The replaceable bearing surface comprises an outer housing and a low-friction, abrasion resistant button secured within the outer housing. The outer housing is adapted to be inserted into and removed from a device without damaging the device.

In the preferred embodiment, the button is comprised of Polycrystalline Diamond Compact (PDC). Preferably, the outer housing is comprised of 41/30 steel. The button is preferably press fit into the outer housing. Preferably, the outer housing has a notched grip portion and the outer housing has a threaded portion. The threaded portion of the outer housing is preferably adapted to mate with a threaded recess in the device.

In the preferred embodiment, the button is hemispherical. Preferably, the outer surface of the button extends beyond at least one surface of the outer housing. Preferably, when installed, button extends beyond an exterior surface of the device.

Another embodiment of the invention is directed to a low-friction, abrasion resistant system. The system comprises a device having at least one recess, a plurality of replaceable bearing surfaces adapted to be inserted into and removed from the at least one recess without damaging the device, each replaceable bearing surface comprising an outer housing, and a low-friction, abrasion resistant button secured within the outer housing.

Preferably, the button is comprised of Polycrystalline Diamond Compact (PDC). In the preferred embodiment, the outer housing is comprised of 41/30 steel. Preferably, the button is press fit into the outer housing. In the preferred embodiment, the outer housing has a notched grip portion and a threaded portion. Preferably, the threaded portion of the outer housing is adapted to mate with a threaded recess in the device.

Preferably, the button is hemispherical. Preferably, the outer surface of the button extends beyond at least one surface of the outer housing. In the preferred embodiment, when installed, button extends beyond an exterior surface of the device. The device is preferably one of a drill bit, a reamer, a cam shaft, a bearing, or an axle.

Another embodiment of the invention is directed to a method of installing and removing a replaceable bearing surface without damaging the device.

Other embodiments and advantages of the invention are set forth in part in the description, which follows, and in part, may be obvious from this description, or may be learned from the practice of the invention.

### DESCRIPTION OF THE DRAWING

The invention is described in greater detail by way of example only and with reference to the attached drawing, in which:

FIG. 1 is an isometric view of an embodiment of the bearing surface of the invention.

FIG. 2 is a top view of an embodiment of the bearing surface of the invention.

FIG. 3 is a cut-away view of an embodiment of the bearing surface of the invention.

FIG. 4 is a side view of an embodiment of the bearing surface installed in a device.

### DESCRIPTION OF THE INVENTION

As embodied and broadly described herein, the disclosures herein provide detailed embodiments of the invention. However, the disclosed embodiments are merely exemplary of the invention that may be embodied in various and alternative forms. Therefore, there is no intent that specific structural and functional details should be limiting, but rather the intention is that they provide a basis for the claims and as a representative basis for teaching one skilled in the art to variously employ the present invention.

A problem in the art capable of being solved by the embodiments of the present invention is replacing worn out bearing surfaces quickly and on-site. It has been surprisingly discovered that providing a replaceable low-friction, abrasion and impact resistant bearing surface allows technicians to replace worn out bearing surfaces themselves without transporting the device to a specialty facility.

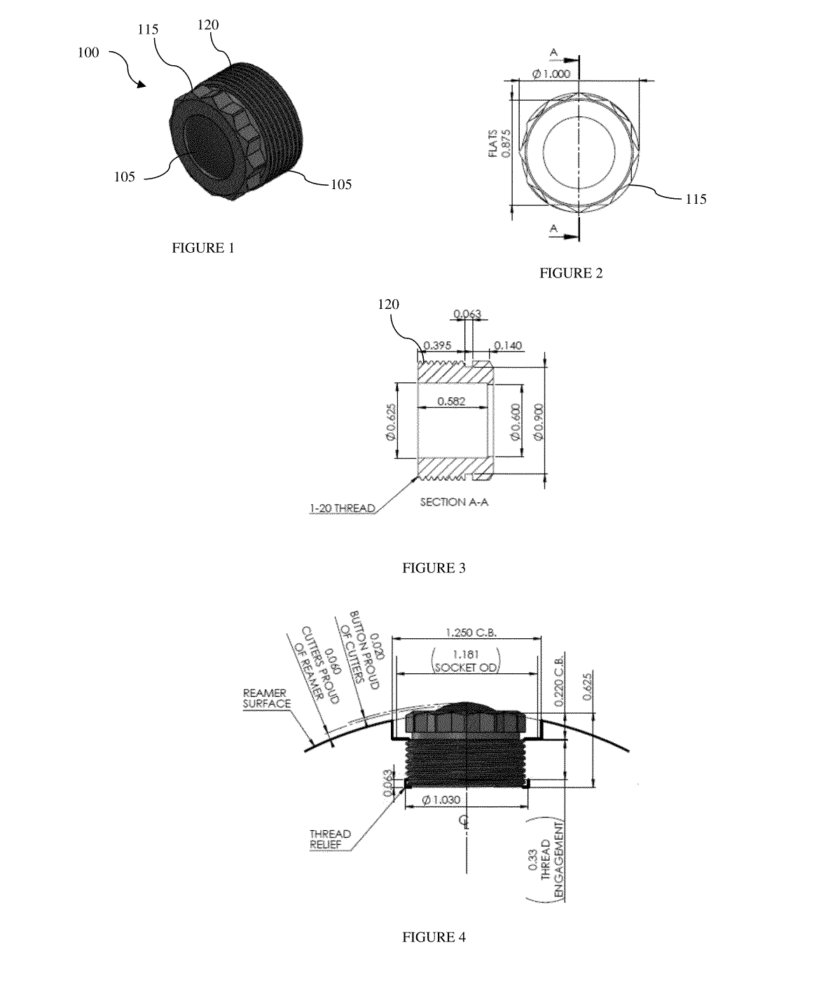

FIG. 1 depicts an isometric view of a preferred embodiment of the replaceable bearing surface 100. Bearing surface 100 is comprised of an outer housing 105 and a slider button 110. While one slider button 110 is shown, another number of slider buttons can be used, for example, two or four slider buttons can be used. Preferably, the slider button 110 is a PDC, which has a lower coefficient of friction that carbide or hardened steels. The low coefficient of friction reduces drag during use of the device and thus reduces torque, for example, during drilling of lateral well bores. However, other materials, such as aluminum oxide, silicon carbide, or cubic boron nitride can be used. In the preferred embodiment, slider button 110 is semi-spherical, however other shapes (for example, rectangular, triangular, or semi-ovoidal) can be implemented. Additionally, slider button 110 can be a combination of shapes. Slider button 110 is preferably press fit into outer housing 105. However, slider button 110 can be coupled to outer housing 105, for example, with bolts, screws, adhesive, other fastening devices, or screwed into outer housing 105.

Preferably, outer housing 105 is comprised of 41/30 steel, however other steels or other materials can be used for outer housing 105. For example, nylon, other metals, plastics, carbon-fiber, or other naturally occurring or manmade materials. As can be seen in FIG. 2, outer housing 105 is preferably cylindrical, having an outer diameter of about one inch. However, outer housing 105 can have other dimensions depending on the device into which bearing surface 100 is installed. For example, outer housing 105 can have a diameter of ½ an inch, 2 inches, or 3 inches. Outer housing 105 preferably has a notched portion 115 on the outer diameter, adjacent to slider button 110. Notched portion 115 is preferably adapted to be griped by a wrench, pliers, or a person's fingers. Notched portion 115 preferably aids in installing and uninstalling bearing surface 110 by providing a gripable surface. Outer housing 105 can additionally have other gripping surfaces or a smooth surface. For example, outer housing 105 can have raised knurling, a rubberized grip, or other high friction surfaces.

FIG. 3 depicts a cut-away side view of bearing surface 100. Outer housing 105 additionally preferably comprises a threaded portion 120. Threaded portion 120 preferably is able to mate with a threaded socket in the apparatus into which bearing surface 100 is to be installed. In other embodiments, instead of or in addition to treaded portion 120, outer housing 105 may have a spring biased cam, a friction increasing device, a pin, adhesive, or another fastening device to keep bearing surface 100 from unintentionally coming out of the apparatus. Preferably, the coupling device is capable of maintaining the outer housing 105 within the apparatus during use of the apparatus and under high stress and high heat conditions.

As shown in FIG. 4, bearing surface 100 is couplable with a device or apparatus. In the preferred embodiment the bearing surface 100 is counter sunk into the device so that only a portion of the bearing surface 100 extends beyond the exterior or the device. For example, only the slider button 110 may extend beyond the exterior of the device. The device can be a drill bit, a reamer, a cam shaft, a bearing, an axle, another machine part, or any other device requiring a low-friction surface. Preferably, the device has a recess with threaded sides that mates with threaded portion 120 of outer housing 105. In embodiments where outer housing 105 has another fixation device, the recess may have other mating devices. Preferably, the bearing surface 100 can be replaced at the location of use of the device with common tools (for example wrenches, pliers, or screw drivers). Preferably, the bearing surface 100 can be replaced without heating and/or cooling the device, thereby reducing the stress on the device caused during the refurbishment techniques used previously. Additionally, the precision tolerances of the devices can be maintained and repeated during replacement of the bearing surface 100. Since the bearing surface 100 can preferably be replaced on-site, a transportation cost savings is realized by reducing the number of trips to repair centers. Furthermore, redundant inventory can be reduced since the time previously necessary for shipping and repair is eliminated.

Other embodiments and uses of the invention will be apparent to those skilled in the art from consideration of the specification and practice of the invention disclosed herein. All references cited herein, including all publications, U.S. and foreign patents and patent applications, are specifically and entirely incorporated by reference. It is intended that the specification and examples be considered exemplary only with the true scope and spirit of the invention indicated by the following claims. Furthermore, the term “comprising of” includes the terms “consisting of” and “consisting essentially of.”

1. A replaceable bearing surface, comprising:
an outer housing; and
a low-friction, abrasion resistant button secured within the outer housing;
wherein the outer housing is adapted to be inserted into and removed from a device without damaging the device.

2. The replaceable bearing surface of claim 1, wherein the button is comprised of Polycrystalline Diamond Compact (PDC).

3. The replaceable bearing surface of claim 1, wherein the outer housing is comprised of 41/30 steel.

4. The replaceable bearing surface of claim 1, wherein the button is press fit into the outer housing.

5. The replaceable bearing surface of claim 1, wherein the outer housing has a notched grip portion.

6. The replaceable bearing surface of claim 1, wherein the outer housing has a threaded portion.

7. The replaceable bearing surface of claim 6, wherein the threaded portion of the outer housing is adapted to mate with a threaded recess in the device.

8. The replaceable bearing surface of claim 1, wherein the button is hemispherical.

9. The replaceable bearing surface of claim 8, wherein the outer surface of the button extends beyond at least one surface of the outer housing.

10. The replaceable bearing surface of claim 8, wherein, when installed, button extends beyond an exterior surface of the device.

11. A low-friction, abrasion resistant system, comprising:
a device having at least one recess;
a plurality of replaceable bearing surfaces adapted to be inserted into and removed from the at least one recess without damaging the device, each replaceable bearing surface comprising:
an outer housing; and
a low-friction, abrasion resistant button secured within the outer housing.

12. The system of claim 11, wherein the button is comprised of Polycrystalline Diamond Compact (PDC).

13. The system of claim 11, wherein the outer housing is comprised of 41/30 steel.

14. The system of claim 11, wherein the button is press fit into the outer housing.

15. The system of claim 11, wherein the outer housing has a notched grip portion.

16. The system of claim 11, wherein the outer housing has a threaded portion.

17. The system of claim 16, wherein the threaded portion of the outer housing is adapted to mate with a threaded recess in the device.

18. The system of claim 11, wherein the button is hemispherical.

19. The system of claim 18, wherein the outer surface of the button extends beyond at least one surface of the outer housing.

20. The system of claim 18, wherein, when installed, button extends beyond an exterior surface of the device.

21. The system of claim 11, wherein the device is one of a drill bit, a reamer, a cam shaft, a bearing, or an axle.

22. A method of installing and removing the replaceable bearing surface of claim 1 without damaging the device.
